(19) United States
(12) Patent Application Publication
(10) Pub. No.: US 2021/0127660 A1
(43) Pub. Date: May 6, 2021

(54) Herbicide Application Device

(71) Applicant: Ricky Snoddy, Gatesville, TX (US)

(72) Inventor: Ricky Snoddy, Gatesville, TX (US)

(21) Appl. No.: 16/669,597

(22) Filed: Oct. 31, 2019

(51) Int. Cl. A01M 21/04

(52) U.S. Cl. CPC A01M 21/043

(57) ABSTRACT

An herbicide application device for targeting application of an herbicide to a weed includes a rod and a tube. A recess extends into the rod from a first endpoint of the rod. The tube is selectively insertable into the recess to removably couple the tube to the rod so that a first end of the tube protrudes from the rod. The tube has a second end that is closed. Each of a set of applicators is selectively couplable to the first end of the tube. The applicator is configured to transfer an herbicide that is positioned in the tube to a plant, such as a weed, in a targeted manner to avoid inadvertent application of the herbicide to desired plants.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to application devices and more particularly pertains to a new application device for targeting application of an herbicide to a weed.

### (2) Description of Related Art Including Information Disclosed Under 37 CFR 1.97 and 1.98

The prior art relates to application devices.

### BRIEF SUMMARY OF THE INVENTION

An embodiment of the disclosure meets the needs presented above by generally comprising a rod and a tube. A recess extends into the rod from a first endpoint of the rod. The tube is selectively insertable into the recess to removably couple the tube to the rod so that a first end of the tube protrudes from the rod. The tube has a second end that is closed. Each of a set of applicators is selectively couplable to the first end of the tube. The applicator is configured to transfer an herbicide that is positioned in the tube to a plant, such as a weed, in a targeted manner to avoid inadvertent application of the herbicide to desired plants.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an herbicide application device according to an embodiment of the disclosure.

FIG. 2 is an isometric perspective view of an embodiment of the disclosure.

FIG. 3 is a cross-sectional view of an embodiment of the disclosure.

FIG. 4 is an in-use view of an embodiment of the disclosure.

### DETAILED DESCRIPTION OF THE INVENTION

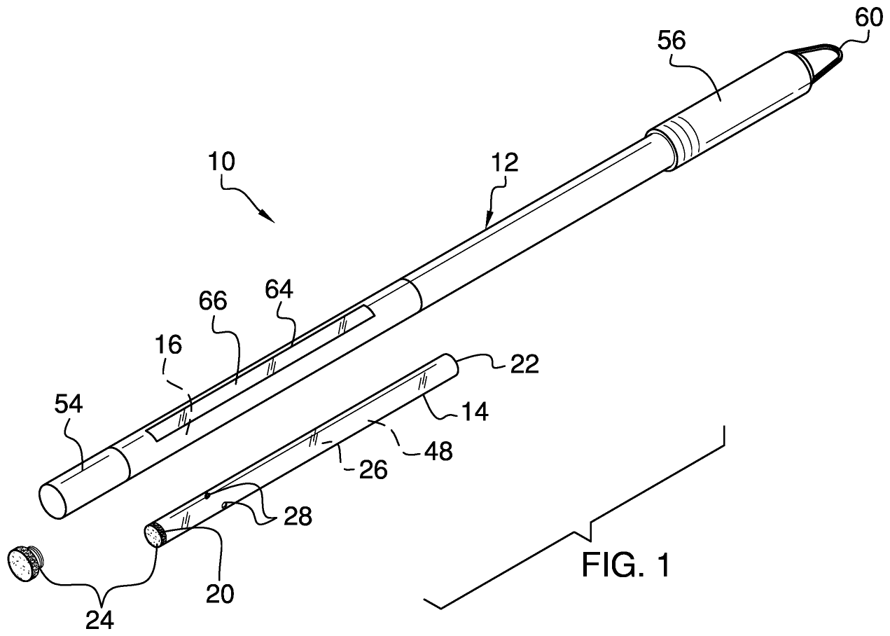

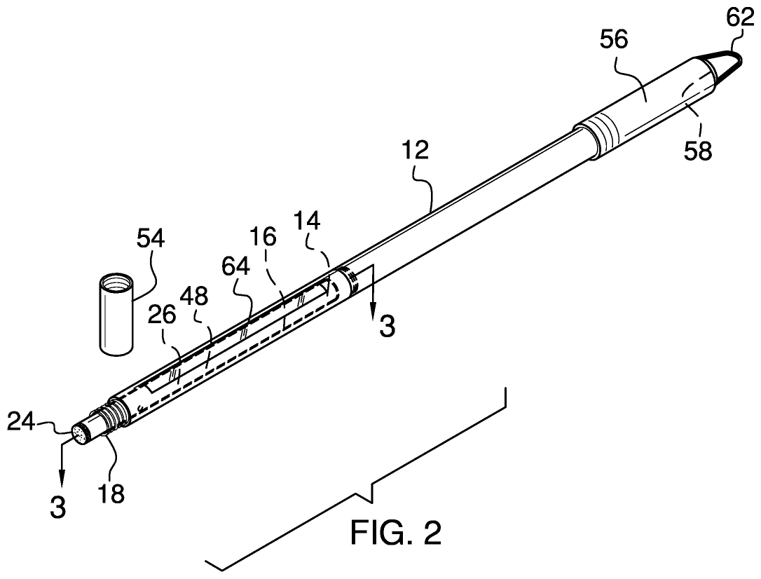

With reference now to the drawings, and in particular to FIGS. 1 through 4 thereof, a new application device embodying the principles and concepts of an embodiment of the disclosure and generally designated by the reference numeral 10 will be described.

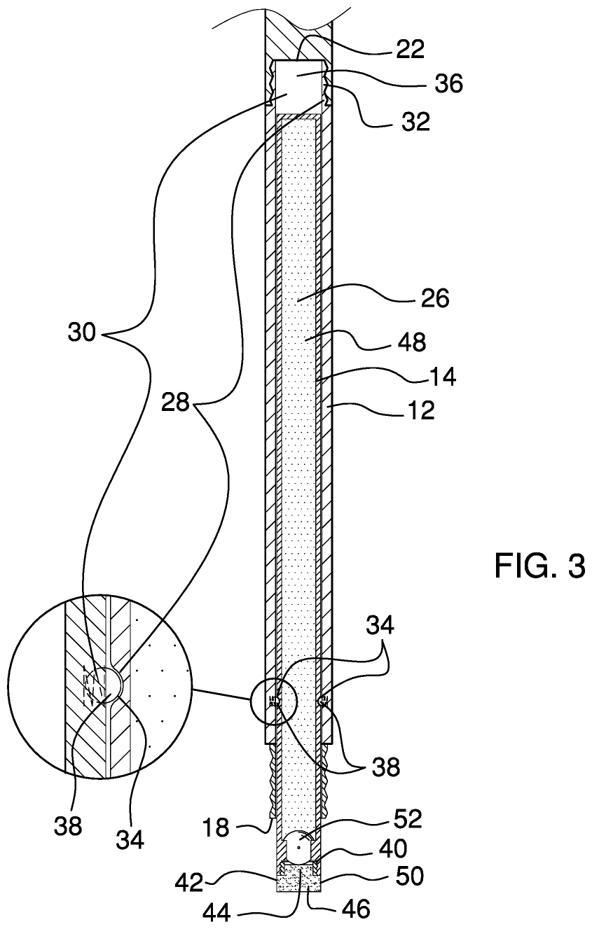

As best illustrated in FIGS. 1 through 4, the herbicide application device 10 generally comprises a rod 12 and a tube 14. The rod 12 comprises at least one of plastic and metal. A recess 16 extends into the rod 12 from a first endpoint 18 of the rod 12. The tube 14 is selectively insertable into the recess 16, as shown in FIG. 3, to removably couple the tube 14 to the rod 12 so that a first end 20 of the tube 14 protrudes from the rod 12. The tube 14 has a second end 22 that is closed.

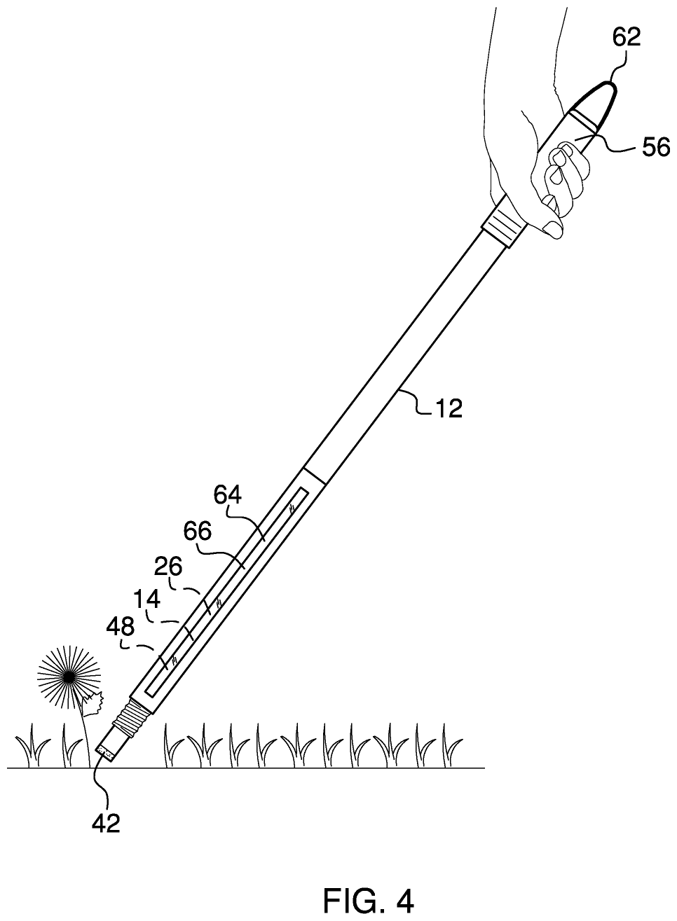

Each of a set of applicators 24 is selectively couplable to the first end 20 of the tube 14. The applicator 24 is configured to transfer an herbicide 26 that is positioned in the tube 14 to a plant, such as a weed, as shown in FIG. 4, in a targeted manner to avoid inadvertent application of the herbicide 26 to desired plants.

The herbicide 26 may be in free-flowing liquid form, viscous liquid form, and gel form. The herbicide 26 may comprise a dye 48 so that the herbicide 26 is colored. The herbicide 26 being colored provides visual feedback to a user regarding application of the herbicide 26 to the plant.

The rod 12, the tube 14, and the recess 16 all may be circularly shaped when viewed longitudinally, although the present invention anticipates other shapes for the rod 12, the tube 14, and the recess 16, such as, but not limited to, rectangularly shaped when viewed longitudinally, ovally shaped when viewed longitudinally, and the like. Additionally, the rod 12 and the tube 14 may be differentially shaped, but the tube 14 must be shaped complementarily to the recess 16.

A first coupler 28 is coupled to the tube 14. A second coupler 30 is coupled to the rod 12. The second coupler 30 is complementary to the first coupler 28 so that the second coupler 30 is positioned to selectively couple to the first coupler 28 to removably couple the tube 14 to the rod 12.

The second coupler 30 comprises at least one of a set of external threads 32, which is positioned proximate to the second end 22 of the tube 14, and a set of indents 34 that is positioned proximate to the first end 20 of the tube 14. The first coupler 28 comprises at least one of a threaded socket 36, which extends from the recess 16 longitudinally into the rod 12, and a set of pins 38. The pins 38 are spring loaded so that each pin 38 is positioned to selectively insert into a respective indent 34 to removably couple the tube 14 to the rod 12. Each pin 38 may be spherically shaped, as shown in FIG. 3, so that the pin 38 is configured to roll along the tube 14 as the tube 14 is inserted into the recess 16.

The set of external threads 32 is complementary to the threaded socket 36 so that the set of external threads 32 is positioned to be selectively threadedly inserted into the threaded socket 36 to removably couple the tube 14 to the rod 12. As shown in FIG. 3, the device 10 may comprise both the threaded socket 36 and the set of pins 38, along with both the set of external threads 32 and the set of indents 34.

The tube 14 is internally threaded proximate to the first end 20, as shown in FIG. 3. Each applicator 24 comprises a ring 40 and a sponge 42. The ring 40 is externally threaded so that the ring 40 is positioned to be threadedly inserted into the first end 20 of the tube 14 to removably couple the applicator 24 to the tube 14. The sponge 42 comprises a stub 44 and a disc 46. The stub 44 is positioned in and is coupled to the ring 40. The disc 46 is coupled to the stub 44 so that the disc 46 is external to the tube 14 when the disc 46 is threadedly inserted into the tube 14.

Each disc 46 of the set of applicators 24 has a respective circumference 50 so that the set of applicators 24 comprises discs 46 that have a variety of circumferences 50. A user thus is positioned to select an applicator 24 that has a disc 46 with a circumference 50 suited to the herbicide application needs of the user.

A ball 52 is rotationally coupled to and positioned within the tube 14 proximate to the first end 20 of the tube 14, as shown in FIG. 3. The ball 52 is positioned to rotate relative to the tube 14 to transfer the herbicide 26 from the tube 14 to the sponge 42.

The rod 12 may be externally threaded proximate to the first endpoint 18 of the rod 12. A cap 54, as shown in FIG. 3, is selectively threadedly couplable to the first endpoint 18 of the rod 12 to close the first end 20 of the tube 14 to retain the herbicide 26 within the tube 14. The cap 54 may be positioned over the applicator 24 that is coupled to the tube 14, thus helping to prevent drying of the herbicide 26 in the sponge 42. The present invention anticipates the cap 54 being couplable to the rod 12 by other coupling means, such as, but not limited to, snap cap closures, gasket closures, and the like.

A grip 56 is coupled to the rod 12 proximate to a second endpoint 58 of the rod 12. The grip 56 is configured to enhance a grasp of a hand of the user upon the rod 12, as shown in FIG. 4. A fastener 60 that is coupled to the grip 56 is configured to couple to a surface, such as a wall, to couple the rod 12 to the surface to stow the rod 12. The fastener 60 may comprise a loop 62 that is configured to insert a surface mounted article of hardware, such as a hook, a nail, and the like, to couple the rod 12 to the surface. The fastener 60 also may comprise other fastening means, such as, but not limited to, suction cups, hook and loop fasteners, and the like.

The tube 14 is substantially transparent. A cutout 64 that is positioned in the rod 12 opens into the recess 16 so that the cutout 64 is configured to allow viewing of a level of the herbicide 26 that is positioned in the tube 14. The device 10 may comprise a panel 66 that is coupled to the rod 12 and which extends over the cutout 64. The panel 66 is substantially transparent and is configured to allow viewing of the level of the herbicide 26 that is positioned in the tube 14. The present invention anticipates the tube 14/herbicide 26 combination being single use, as well as the tube 14 being refillable with the herbicide 26.

In use, an applicator 24 is selected by the user and threadedly coupled to the tube 14. The tube 14 is inserted into the recess 16 and the second end 22 of the tube 14 is threadedly inserted into the threaded socket 36 to couple the tube 14 to the rod 12. The user then is positioned to apply the herbicide 26 in a targeted manner to plants to kill the plants.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. An herbicide application device comprising:
a rod;
a recess extending into the rod from a first endpoint of the rod;
a tube selectively insertable into the recess for removably coupling the tube to the rod such that a first end of the tube protrudes from the rod, the tube having a second end, the second end being close;
an herbicide positioned in the tube; and
a set of applicators, each applicator being selectively couplable to the first end of the tube wherein the applicator is configured for transferring the herbicide from the tube to a plant in a targeted manner.

2. The device of claim 1, further including the rod comprising at least one of plastic and metal.

3. The device of claim 1, further including the herbicide comprising a dye such that the herbicide is colored.

4. The device of claim 1, further comprising:
a first coupler coupled to the tube; and
a second coupler coupled to the rod, the second coupler being complementary to the first coupler such that the second coupler is positioned for selectively coupling to the first coupler for removably coupling the tube to the rod.

5. The device of claim 4, further comprising:
the recess being circularly shaped when viewed longitudinally;
the tube being circularly shaped when viewed longitudinally; and
the second coupler comprising at least one of a set of external threads positioned proximate to the second end of the tube and a set of indents positioned proximate to the first end of the tube, the first coupler comprising at least one of a threaded socket extending from the recess longitudinally into the rod and a set of pins, the pins being spring loaded such that each pin is positioned for selectively inserting into a respective indent for removably coupling the tube to the rod, the set of external threads being complementary to the threaded socket such that the set of external threads is positioned for selectively threadedly inserting into the threaded socket for removably coupling the tube to the rod.

6. The device of claim 5, further including each pin being spherically shaped such that the pin is configured for rolling along the tube as the tube is inserted into the recess.

7. The device of claim 1, further comprising:
the tube being circularly shaped when viewed longitudinally;
the tube being internally threaded proximate to the first end; and
each applicator comprising a ring and a sponge, the ring being externally threaded such that the ring is positioned for threadedly inserting into the first end of the tube for removably coupling the applicator to the tube, the sponge comprising a stub and a disc, the stub being positioned in and coupled to the ring, the disc being coupled to the stub such that the disc is external to the tube when the disc is threadedly inserted into the tube.

8. The device of claim 7, further including each disc of the set of applicators having a respective circumference such that the set of applicators comprises discs having a variety of circumferences.

9. The device of claim 7, further including a ball rotationally coupled to and positioned within the tube proximate to the first end of the tube such that the ball is positioned for rotating relative to the tube for transferring the herbicide from the tube to the sponge.

10. The device of claim 1, further comprising:
the rod being circularly shaped when viewed longitudinally;
the rod being externally threaded proximate to the first endpoint of the rod; and
a cap selectively threadedly couplable to the first endpoint of the rod for closing the first end of the tube for retaining the herbicide within the tube.

11. The device of claim 1, further including a grip coupled to the rod proximate to a second endpoint of the rod wherein the grip is configured for enhancing a grasp of a hand of a user upon the rod.

12. The device of claim 11, further including a fastener coupled to the grip, the fastener being configured for coupling to a surface wherein the fastener is configured for coupling the rod to the surface for stowing the rod.

13. The device of claim 12, further including the fastener comprising a loop wherein the loop is configured for inserting a surface mounted article of hardware for coupling the rod to the surface.

14. The device of claim 1, further comprising:
the tube being substantially transparent; and
a cutout positioned in the rod such that the cutout opens into the recess wherein the cutout is configured for viewing a level of the herbicide positioned in the tube.

15. The device of claim 14, further including a panel coupled to the rod and extending over the cutout, the panel being substantially transparent wherein the panel is configured for viewing the level of the herbicide positioned in the tube.

16. An herbicide application device comprising:
a rod, the rod being circularly shaped when viewed longitudinally, the rod being externally threaded proximate to a first endpoint of the rod, the rod comprising at least one of plastic and metal;
a recess extending into the rod from the first endpoint of the rod, the recess being circularly shaped when viewed longitudinally;
a tube selectively insertable into the recess for removably coupling the tube to the rod such that a first end of the tube protrudes from the rod, the tube having a second end, the second end being close, the tube being circularly shaped when viewed longitudinally, the tube being substantially transparent, the tube being internally threaded proximate to the first end;
an herbicide positioned in the tube, the herbicide comprising a dye such that the herbicide is colored;
a first coupler coupled to the tube;
a second coupler coupled to the rod, the second coupler being complementary to the first coupler such that the second coupler is positioned for selectively coupling to the first coupler for removably coupling the tube to the rod, the second coupler comprising at least one of a set of external threads positioned proximate to the second end of the tube and a set of indents positioned proximate to the first end of the tube, the first coupler comprising at least one of a threaded socket extending from the recess longitudinally into the rod and a set of pins, the pins being spring loaded such that each pin is positioned for selectively inserting into a respective indent for removably coupling the tube to the rod, the set of external threads being complementary to the threaded socket such that the set of external threads is positioned for selectively threadedly inserting into the threaded socket for removably coupling the tube to the rod, each pin being spherically shaped such that the pin is configured for rolling along the tube as the tube is inserted into the recess;
a set of applicators, each applicator being selectively couplable to the first end of the tube wherein the applicator is configured for transferring the herbicide from the tube to a plant in a targeted manner, each applicator comprising a ring and a sponge, the ring being externally threaded such that the ring is positioned for threadedly inserting into the first end of the tube for removably coupling the applicator to the tube, the sponge comprising a stub and a disc, the stub being positioned in and coupled to the ring, the disc being coupled to the stub such that the disc is external to the tube when the disc is threadedly inserted into the tube, each disc of the set of applicators having a respective circumference such that the set of applicators comprises discs having a variety of circumferences;
a ball rotationally coupled to and positioned within the tube proximate to the first end of the tube such that the ball is positioned for rotating relative to the tube for transferring the herbicide from the tube to the sponge;
a cap selectively threadedly couplable to the first endpoint of the rod for closing the first end of the tube for retaining the herbicide within the tube;
a grip coupled to the rod proximate to a second endpoint of the rod wherein the grip is configured for enhancing a grasp of a hand of a user upon the rod;
a fastener coupled to the grip, the fastener being configured for coupling to a surface wherein the fastener is configured for coupling the rod to the surface for stowing the rod, the fastener comprising a loop wherein the loop is configured for inserting a surface mounted article of hardware for coupling the rod to the surface;
a cutout positioned in the rod such that the cutout opens into the recess wherein the cutout is configured for viewing a level of the herbicide positioned in the tube; and
a panel coupled to the rod and extending over the cutout, the panel being substantially transparent wherein the panel is configured for viewing the level of the herbicide positioned in the tube.
